(19) United States
(12) Patent Application Publication
(10) Pub. No.: US 2004/0182792 A1
(43) Pub. Date: Sep. 23, 2004

(54) Apparatus for purification of industrial wastewater with thin film fixed bed TiO2 photocatalyst

(76) Inventors: Machiraju Subrahmanyam, Andhra Pradesh (IN); Pierre Boule, Auberie Cedex (FR); Durga Kumari Valluri, Andhra Pradesh (IN); Maddigapu Pratap Reddy, Andhra Pradesh (IN); Mohammed Noorjahan, Andhra Pradesh (IN); Kondapuram Vijaya Raghavan, Andhra Pradesh (IN)

Correspondence Address: NIXON & VANDERHYE, PC, 1100 N GLEBE ROAD, 8TH FLOOR, ARLINGTON, VA, 22201-4714, US

(21) Appl. No.: 10/392,386

(22) Filed: Mar. 20, 2003

(51) Int. Cl. C02F 1/72

(52) U.S. Cl. 210/748; 210/763; 210/198.1

(57) ABSTRACT

An apparatus for the photocatalyitc oxidation of common industrial effluent contaminants in aqueous solution includes a reactor and a thin film photocatalyst fixed to a support material like Cuddapah stone. The support material is preferably an inert material. The TiO₂ preformed does not contain any adsorbent for making the thin film photocatalyst, The catalytic runs were carried out over TiO₂ thin film fixed bed reactor. The study is extended to the immobilization of preformed TiO₂ with a binder for making thin film using a simple spray technique on inert Cuddapah stone. This method of immobilization require no thermal treatment of the catalyst at high temperatures. The method is applicable for the photocatalytic treatment of industrial effluents at a higher scale. Also it is a method for preparing a photocatalyst adopted for the oxidation of industrial common effluent by simple spray technique. Also it is a method and apparatus for destroying industrial common effluent contaminants in aqueous solution

### FIELD OF THE INVENTION

The invention relates to an apparatus for catalytic purification of industrial wastewater using a thin film fixed bed TiO₂ photocatalyst. The present invention also relates to a catalytic method for the treatment of industrial wastewater. More specifically, the present invention provides an apparatus for destroying recalcitrant compounds in industrial wastewater by photocatalytic oxidation.

### BACKGROUND OF THE INVENTION

India has experienced important economic growth in the drug, dye, drug/dye intermediate industries during the last three decades. This development is accompanied also with extremely high water contamination of several lakes and drinking water sources surrounded by the industries with a variety of recalcitrant materials. Advanced treatment methods (i.e. ozonation, membrane filtration, activated carbon adsorption) are overcome more recently by the use of Advanced Oxidation Processes (AOP). An inherent advantage of heterogeneous photocatalysis emerges when solar radiation is used as the photon source. Since two decades heterogeneous photocatalytic treatment of toxic and hazardous model pollutants have already been discussed in the scientific published and patented literature [D. M. Blake, Bibliography of work on Photocatalytic Removal of Hazardous Compounds from Water and Air, NREL/TP-430-22197, National Renewable Energy Laboratory, Golden, Colo., 1999]. The use of aqueous suspensions limits practical applications because of problems of separation of fine particles of TiO₂ and the recycling of the particles. Many techniques were proposed for the immobilization of TiO₂ on solid supports to eliminate this problem [S. Malato, J. Blanco, A. Vidal and C. Richter; Appl. Catal. B Environ. 37 (2002) 1 and references therein and U.S. Pat. No. 5,541,096, JP 2000237759, U.S. Pat. No. 5,779,912. A. Mills and S. K. Lee; J. Photochem. Photobiol. A Chem 152(2002)233].

The major current commercial applications of semiconductor photochemistry and their engineering system and design methodologies have been started only very recently. Prior art processes relying on the use of supported TiO₂ are commonly reported to be less photoactive The process of immobilization generally involves use of expensive precursors of TiO₂ in the form of sol-gel and thermal treatment of film between 400° and 500° C.

### OBJECTS OF THE INVENTION

The main object of the present invention is to provide an apparatus for the photocatalytic treatment of industrial wastewater that obviates above-mentioned drawbacks.

It is another object of the present invention to provide an apparatus for the photocatalytic treatment of industrial wastewater which enables easy removal of recalcitrant contaminants with easy recycling of the TiO₂.

It is another object of the invention, to provide a method for the degradation of recalcitrant contaminants in industrial wastewater by photocatalytic oxidation thereof using a TiO₂ thin film fixed bed reactor which is economical and environmentally friendly.

### SUMMARY OF THE INVENTION

This present invention is aimed at utilising photocatalytic treatment of live industrial wastewater containing hazardous contaminants from common effluent treatment plants by using TiO₂ (Degussa P25) thin film fixed bed reactor (TFFBR) for degradation thereof.

Accordingly, the present invention provides an apparatus for catalytic purification of industrial wastewater using a thin film fixed bed TiO₂ photocatalyst comprising a reactor with at least an inert support forming the base thereof and walls rising from the said base, said inert support comprising at least two sides, a uniform film comprising a mixture of TiO₂ and binder affixed on one side thereof, inlets to allow flow of industrial wastewater over the uniform TiO₂ film coated support and outlets to allow outflow of treated industrial wastewater, said inert bed being open to exposure on the coated side thereof.

In one embodiment of the invention, the inert support comprises a solid support.

In another embodiment of the invention, the solid support comprises of Cuddapah stone obtained from Andhra Pradesh in India.

The present invention also relates to a method for the manufacture of an apparatus for photocatalytic treatment of industrial wastewater using a thin film fixed bed TiO₂ photocatalyst, said apparatus comprising a reactor with at least an inert support forming the base thereof and walls rising from the said base, said inert support comprising at least two sides, a uniform film comprising a mixture of TiO₂ and binder affixed on one side thereof, inlets to allow flow of industrial wastewater over the uniform TiO₂ film coated support and outlets to allow outflow of treated industrial wastewater, said inert bed being open to exposure on the coated side thereof, said method comprising, mixing TiO₂ with a binder to form a TiO₂ milk, coating said inert support with said TiO₂ composition to form at least a first film layer and drying the coated support.

In one embodiment of the invention, the TiO₂ composition is coated with at least a further layer till a uniform fracture/pore free film layer is obtained immobilized on support.

In another embodiment of the invention, the TiO₂ comprises of TiO₂ Degussa P25 with particle size of 30 nm and surface area of 50 m²g⁻¹.

In yet another embodiment of the invention, the binder is selected from the group comprising of surfactants, acrylic emulsions and resins.

In a further embodiment of the invention, the surfactants are selected from the group consisting of Doss 50%, Polyethylene glycol polymer (PEG-600), benzyl konium chloride 50% and VIBSOL-EL-40 (Ethoxylated product 40 moles (Castor oil based),

In another embodiment of the invention, the resin binder is ST-BA-AA resin.

In yet another embodiment of the invention, the inert support is a solid support.

In another embodiment of the invention, the solid support comprises of Cuddapah stone obtained from Andhra Pradesh in India.

The present invention also provides a method for the treatment of industrial wastewater comprising passing a wastewater stream over an apparatus comprising a reactor with at least an inert support forming the base thereof and walls rising from the said base, said inert support comprising at least two sides, a uniform film comprising a mixture of TiO₂ and binder affixed on one side thereof, inlets to allow flow of industrial wastewater over the uniform TiO₂ film coated support and outlets to allow outflow of treated industrial wastewater, said inert bed being open to exposure on the coated side thereof, and exposing said industrial wastewater to illumination to enable the degradation of the contaminants contained in said wastewater due to the catalytic activity of the TiO₂ film.

In one embodiment of the invention, the source of illumination is solar energy.

In another embodiment of the invention, the contaminants in the wastewater comprise para nitro phenol, para nitro toluene sulfonic acid, meta phenylene diamine sulfonic acid Paracetamol, Dinitro stilbene disulphonic acid, H-acid, Diamino stilbene disulfonic acid, para amino phenol, para amino azobenzene disulfonic acid, Acetic anhydride and K-acid.

In one embodiment of the invention, the TiO₂ composition is coated with at least a further layer till a uniform fracture/pore free film layer is obtained immobilized on support.

In another embodiment of the invention, the TiO₂ comprises of TiO₂ Degussa P25 with particle size of 30 nm and surface area of 50 m²g⁻¹.

In yet another embodiment of the invention, the binder is selected from the group comprising of surfactants, acrylic emulsions and resins.

In a further embodiment of the invention, the surfactants are selected from the group consisting of Doss 50%, Polyethylene glycol polymer (PEG-600), benzyl konium chloride 50% and VIBSOL-EL-40 (Ethoxylated product 40 moles (Castor oil based).

In another embodiment of the invention, the resin binder is ST-BA-AA resin.

In yet another embodiment of the invention, the inert support is a solid support.

In another embodiment of the invention, the solid support comprises of Cuddapah stone obtained from Andhra Pradesh in India.

### BRIEF DESCRIPTION OF THE ACCOMPANYING DRAWINGS

FIG. 1 is a photograph of the TiO₂ thin film fixed bed reactor (TFFBR) made on Cuddapah stone (Size: 144×52×10 cm) apparatus for destroying contaminants in industrial wastewater by solar driven photocatalytic oxidation.

FIG. 2a to c comprise SEM images of surface morphologies of the TiO₂ thin films supported on Cuddapah stone, with FIG. 2a comprising a film of binder without TiO₂, FIG. 2b comprising a TiO₂+ binder film before industrial wastewater treatment and FIG. 2c comprising TiO₂+ binder film after usage of film for treatment of industrial wastewater for a period of 30 days.

FIG. 3a and b show the LTV-VIS DRS absorbance spectra of TiO₂ thin film, wherein FIG. 3a is for before usage for wastewater treatment and FIG. 3b is for after industrial effluent treatment for 30 days usage.

FIG. 4 shows the solar photocatalyitc COD reduction of industrial common effluent from effluent treatment plants (before their treatment) wherein 4(1) shows COD reduction with the usage of slurry of TiO₂ and FIG. 4(2) shows COD reduction with usage of thin film fixed bed reactor over Cuddapah stone of the invention,

FIG. 5a and b shows the percent COD removal of common industrial effluent wherein FIG. 5a shows the photocatalytic coupled with biological treatment and FIG. 5b shows only for biological treatment.

### DETAILED DESCRIPTION OF THE INVENTION

This invention provides improvement in the destruction of contaminants in industrial common effluents by photocatalysis. More particularly the invention provides an apparatus for photocatalytic degradation of recalcitrant compounds containing in industrial wastewater with the photocatalyst slurry system and also with the thin film fixed bed reactor using P-25 TiO₂ for the existing industrial common effluent (containing several organic and inorganic contaminants) collected (before the company treatment) from common effluent treatment plants at Hyderabad. This study was undertaken to provide a practical assessment of the heterogeneous photocatalytic treatment with titanium dioxide film over fixed Cuddapah stone using live industrial wastewater containing hazardous contaminants from common effluent treatment plants. The apparatus includes a reactor and a photocatalyst. It is made with an embodiment adapted for use with sunlight as the source of irradiation. The support material is a construction material for houses. The support material is not an adsorbent nor it has any binding properties to hold the photocatalyst. In the case of the TiO₂ slurry systems and its derived films the photocatalytic activity was found to be equal for the recalcitrant compounds degradation of the industrial common effluent.

The invention provides the thin film fixed bed reactor is an efficient and attractive design for the treatment of large-scale wastewater systems and their construction offers economic advantages. The support material comprises a tub of specifications given having a bottom surface photocatalyst put under a simple chemical spray technique. More preferably the photocatalyst film is made without any heat treatment. The preparation method includes the steps of mixing the TiO₂ with the binders of respective compositions. In this context, treatment of industrial wastewater, in spite of inefficient production of hydroxyl radicals and slow kinetics, which limit economic feasibility, is one of the most promising fields of application of solar detoxification. It is known that each individual effluent has to be handled considering its own characteristic properties for treatment. In spite of this, the present data encourages photocatalytic treatment of common effluent for detoxification of several pollutants existing with the tested sample as in the present case. The results obtained clearly indicate an inherent advantage of heterogeneous photocatalytic treatment for eliminating contaminants in common industrial effluent plants.

The invention more preferably provides the treatment of common industrial effluent consists of several organic and inorganic recalcitrant compounds. The common effluent is of high COD of more than 15000 mg lt⁻¹ in several instances with intense color and odor. Before the treatment the effluent is filtered and all the solid particles are removed. The early results from the tests using the apparatus of the solar detoxification unit technology are encouraging, as industrial wastewaters were quickly decontaminated to low COD water standards even though they contain several range of organic and inorganic recalcitrant compounds.

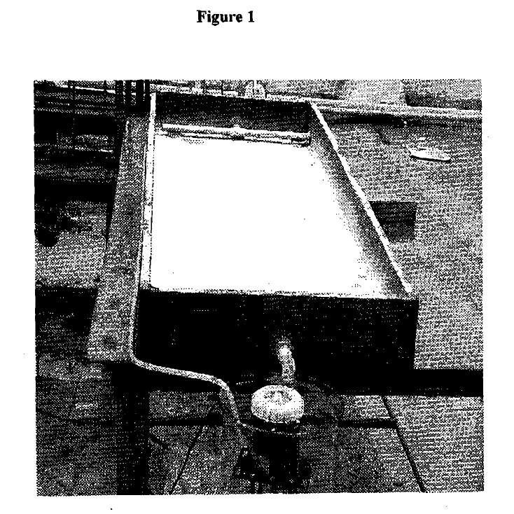

As shown in FIG. 1 TiO₂ Thin film fixed bed reactor (TFFBR) is an apparatus of the present invention for Photocatalytic oxidation of contaminants in industrial wastewaters. The apparatus includes a support used for the immobilization of TiO₂ and it is a solid Cuddapah stone. The stone is cleaned and TiO₂ milk is prepared with TiO₂+ binder mixture (4 gm of TiO₂ in 100-200 ml of water and 1-5 ml of binder) under stirring. The TiO₂+ binder mixture is then coated with a laboratory spray gun. The coated TiO₂ film is left for drying. The coating of the film was repeated until a uniform coating with no pin holes are obtained. A thin film fixed bed reactor is made of Cuddapah stone coated with a thin layer of TiO₂ (size: l=144 cm, b=52 cm, and h=10 cm). Also tubs of (size: l=36.5 cm; b=26.5 cm, and h=10 cm) of three numbers with resin, surfactant and acrylic emulsion as binders. Pollutant water of 5 lt of H-acid or industrial common effluent collected from Common Effluent Treatment Plants available at Hyderabad have been continuously run through the reactor at the flow rate of 750 ml min⁻¹ rate for bigger unit whereas 100 ml min⁻¹ for smaller reactor using circulation pump. Degradation experiments were monitored under solar illumination.

The TiO₂+ binder films used herein are characterized by XRD. The patterns show that the TiO₂ film before treatment is similar to the film used extensively even after 30 days. This was also confirmed from UV-DRS and SEM data. This indicates that TiO₂ is available on the surface of the film and is not embedded into the binder (surfactant, resin, emulsion) matrix. Titanium dioxide is from Degussa P25 (70% anatase and 30% rutile) with particle size of 30 nm and surface area of 50 m²g⁻¹. The binders are surfactants anionic Doss 50%, Polyethylene glycol polymer (PEG-600), BKC 50% cationic (Benzyl Koniurn Chloride), VIBSOL-EL-40 (Ethoxylated product 40 moles (Castor oil based), resins ST-BA-AA etc, In acrylic emulsion the percentage of solids are of 50≠1, viscosity of 4-10 poise; pH 7-9 percent free monomer <0.5, particle size by SEM 0.3-0.5 nm and MFT 20-25° C.

The apparatus is preferably prepared as follows. The stone is cleaned and TiO₂ milk is prepared with TiO₂+ binder mixture (4 gm of TiO₂ in 100-200 ml of water and 1-5 ml of binder) under stirring. The TiO₂+ binder mixture is then coated onto the support with a laboratory spray gun. The support coated with TiO₂ film was left for drying. The film coating was repeated till a uniform coating with no pinholes was obtained. The thin film fixed bed reactor is made of Cuddapah stone coated with a thin layer of TiO₂ (size: l=144 cm; b=52 cm; and h=10 cm). Also tubs of (size: l=36.5 cm; b=26.5 cm; and h=10 cm) of three numbers with resin, surfactant and acrylic emulsion as binders.

Table 1 is a representative of recalcitrant compounds in the industrial common effluent degraded by photocatalyitc thin film fixed bed reactor. The common industrial effluent was collected before its treatment from effluent treatment plant at Hyderabad.

TABLE 1
Some of the organic compounds existing in the common effluent are
para nitro phenol, para nitro toluene sulfonic acid, meta phenylene
diamine sulfonic acid, Paracetamol, Dinitro stilbene disulphonic acid,
H-acid, Diamino stilbene disulfonic acid, para amino phenol, para amino
azobenzene disulfonic acid, Acetic anhydride and K-acid etc.

Table 2 gives some of the physical properties of common effluent which has lot of flexibility depends on the delivery of the individual industry in day-to-day quantum to provide their effluent for treatment at common effluent plants existing at Hyderabad, India,

TABLE 2
Physical properties of industrial common effluent

| Parameters | Batch-1 mg/lt | Batch-2 mg/lt |
|---|---|---|
| COD | 15,540 | 16,000 |
| TOC | 5000 | 5750 |
| TDS (Fixed) | 76,444 | 86,495 |
| TDS (Volatile) | 15,548 | 11,115 |
| Chlorides | — | 27,790 |
| Sodium | — | 26,150 |
| Ammonical Nitrogen as N | — | 56 |
| Sulphate | — | 21,857 |
| pH | 7.1 | 5.46 |

### EXAMPLES

Examples 1-4 related to the destruction of recalcitrant compounds containing wastewater that are detailed in the examples are water containing either H-acid one or more specifically industrial wastewater collected from common industrial effluent treatment plants at Hyderabad. In various examples, the following analytical apparatus and methods were used. UV-VIS DRS of films were recorded on Cintra 10 spectrometer. The TiO₂ thin films were observed in Hitachi S-520 Scanning Electron Microscope. The COD measurements were performed using a HACH COD meter and BOD parameters were analyzed by measuring dissolved oxygen with a DO probe YS1 (5010, USA) instrument. The samples were kept in BOD incubator for 5 days at 20° C. Sulfate ion concentration was quantified spectrophotometrically at 420 nm using a CECIL 2021 spectrophotometer, at the end of each illumination experiment. The thin film fixed bed reactor was made of Cuddapah stone. It is an inert solid support for the immobilization of TiO₂. The TiO₂ is suspended in minimum amount of water (4 gm of TiO₂ in 200-100 ml of water) and 1-5 ml of binder (Surfactant, resin, acrylic emulsion etc) is added under stirring. After cleaning the stone, the TiO₂+ binder mixture was spread with a laboratory spray gun. The coated TiO₂ film was left for air drying. Coating was repeated twice to get a uniform film without pinholes.

### Example 1

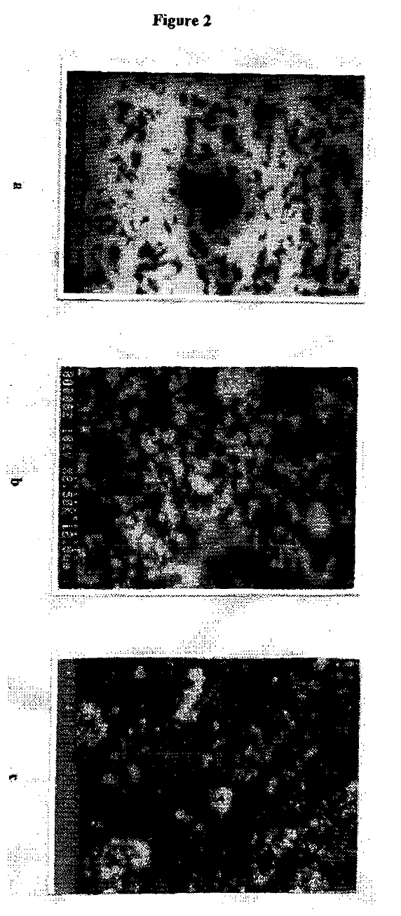

The H-acid (10⁻⁴M) solution of5 L is continuously run through the reactor at the flow rate of 750 ml min⁻¹ using circulation pump. The degradation experiments were monitored under solar illumination. A partial view of the thin film fixed bed photocatalytic reactor is given in FIG. 1. The following characterization of TiO₂ thin films were used. Scanning electron micrographs (SEM): Thin films of TiO₂ prepared by spray technique were analyzed by SEM. FIG. 2 shows the scanning electron micrographs of binder bound TiO₂ thin films a) binder film b) before use and c) after 30 days of use. From the micrographs it is observed that the TiO₂ is present on the surface of the film and that the binder matrix does not cover it. The binder matrix improves the adherence of the photocatalyst that is necessary to obtain a good photocatalytic activity. TiO₂ (white spots in FIG. 2b and 2c) is still present on the films even after continuous use for 30 days. The film is showing good abrasion resistance confirming the stability and good adherence even on continuous use.

### Example 2

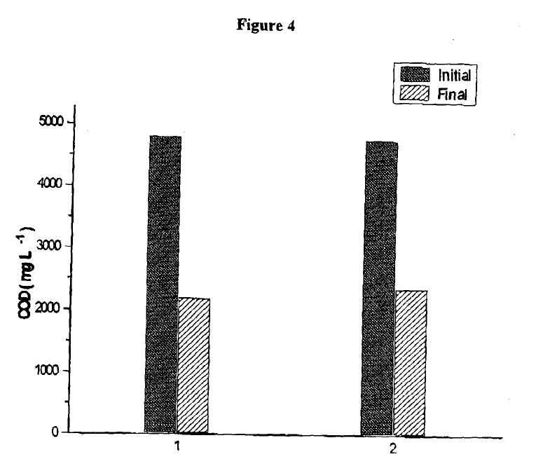

Degradation of H-acid on immobilized TiO₂ using TFFBR was monitored under solar illumination for 3 days. H-acid of 5 L solution was run through TFFBR of area 7488 cm² at a flow rate of 750 ml min⁻¹. To compensate concentration due to evaporation, water was added at regular intervals. Samples collected at end of experiment were analyzed for COD and BOD values in order to evaluate the extent of biodegradability of H-acid. COD removal was 62% and there was an increase of BOD at the end of 3^{rd} day of solar photocatalytic experiments as shown in Table 3. Also the data on common industrial effluent treatment data containing the COD reductions using slurry and thin film fixed bed reactor are given in FIG. 4.

TABLE 3
Photocatalytic degradation of H-acid over TiO₂ suspension
(using UV light) and TiO₂ thin film over Cuddapah
stone (using Solar illumination).

| | TiO₂ Suspension | TiO₂ Film. Irradiation time: |
|---|---|---|
| Parameters | Irradiation time: 5 h (%) | 15 h (3 days) (%) |
| Degradation | 100 | 100 |
| COD removal | 41 | 62 |
| BOD increase | 15 | 18 |

### Example 3

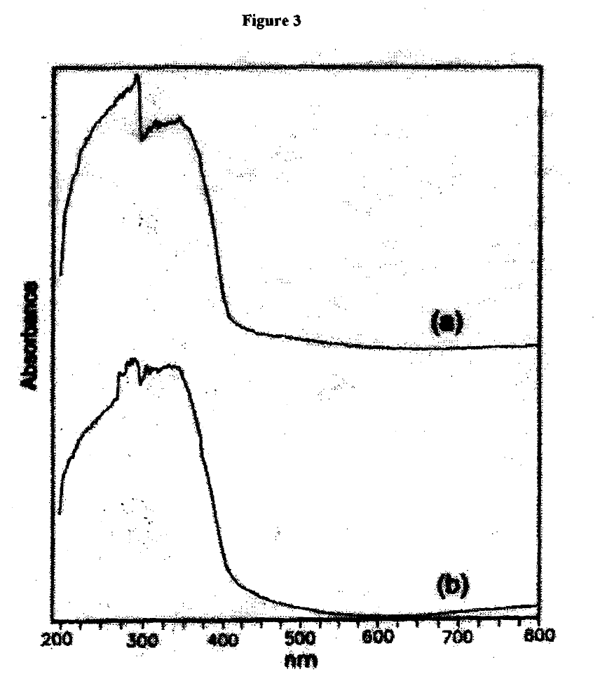

In order to check the role of binder and its interaction with the film if any, the Diffuse Reflectance Spectra of TiO₂ films were recorded. The DRS of the films shows no shift in the band gap of the TiO₂ after immobilization (FIG. 3), Thus the TiO₂ does not interact with the binder which is just used as an adhesive for holding the catalyst intact and enhancing the strength of the film. In the method developed for the immobilization of TiO₂ the adherence of TiO₂ improved by using the binder. On drying, the binder binds TiO₂ to the support surface and forms a matrix like network that maintains TiO₂ particles without affecting their photocatalytic activity. The TFFBR was used continuously in order to test the strength of the film and it was noted at the end of 30 days of treatment, the film was intact and the activity of TiO₂ remained almost unchanged. The film was then analyzed by SEM and DRS. The presence of TiO₂ on the surface of binder matrix is shown in FIG. 2c and 3b. Immobilization of TiO₂ using the emulsion does not bring any interaction between TiO₂ and the binder matrix, since the preparation of the film involves only a physical mixing. It may be noted from DRS spectra of the films that there is no shift in the band gap with binder bound TiO₂.

### Example 4

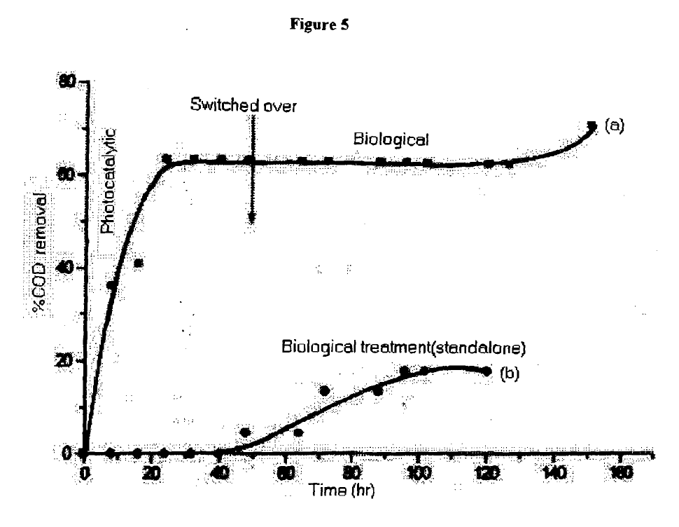

Tests were performed on biological treatment of the common industrial effluent. The wastewater treatment was also performed with a fixed bed photocatalyitc reactor. Reactor setup and experimental procedure were similar to that described earlier As shown in Table 4 and FIG. 5 the destruction ranged a considerable amount for a comparison of biological as well as photocatalyitc treatment suggesting an integrated approach for wastewater treatment

TABLE 4 a & b

| | |
|---|---|
| Sample | COD |

| | | | |
|---|---|---|---|
| (Time in hrs) | PH | (mg/lit) | % removal |

Photocatalytic treatment of common industrial effluent (a)

| | | | |
|---|---|---|---|
| 0 | 8.44 | 4400 | 0 |
| 8 | 8.34 | 2800 | 36.3 |
| 16 | 8.01 | 2600 | 40.9 |
| 24 | 7.29 | 1600 | 63.6 |
| 32 | 7.07 | 1600 | 63.6 |
| 40 | 7.21 | 1600 | 63.6 |

Biological (Anaerobic Sludge Blanket) treatment
of common industrial effluent (b)

| | | | |
|---|---|---|---|
| 0 | 8.44 | 4400 | 0 |
| 24 | 7.21 | 4400 | 0 |
| 48 | 7.18 | 4200 | 4.54 |
| 72 | 7.23 | 3800 | 13.63 |
| 96 | 7.08 | 3600 | 18.18 |
| 120 | 7.08 | 3600 | 18.18 |

Advantages of the Invention

1. P25 TiO₂ is an effective photocatalyst for the degradation of H-acid. From the experiments in suspension and in thin film fixed bed it is noteworthy that H-acid degradation results in a considerable decrease in COD values and an increase in BOD values that proves the reduction in the toxicity of the H-acid thus increasing the biodegradability of the intermediates formed during the photocatalytic degradation.

2. The degradation of H-acid on an immobilized thin film fixed bed reactor is a useful method for the degradation of organic recalcitrant pollutants since it avoids the post-treatment filtration.

3. The method adopted for the immobilization involves preformed TiO₂ and does not require expensive precursors. Photocatalytic films are easily drawn by spray technique and used without any heat treatment.

4, The results suggest that TiO₂ photocatalyst in such an immobilized form is economical and efficient process for the treatment of industrial common effluents at larger scale that may be adopted for diluted wastewaters containing H-acid and several other recalcitrant compounds containing wastewaters.

5. It is also observed that there is decrease in the color intensity and the odor is considerably reduced.

6. The transformation of slurry reactor of lower scale to TFFBR of higher scale wherein a slurry reactor for usage is replaced to a large scale applications of wastewater treatment can be easily done without loosing the photocatalyitc activity.

7. The method of treatment uses solar light and is therefore inexpensive.

8. The catalyst is reused after separation and washing of the film.

9. The method of the invention has the beneficial affect of continuous process mode that is achieved by the immobilized thin film fixed bed photocatalyst containing inert Cuddapah stone support.

We claim

1. An apparatus for catalytic purification of industrial wastewater using a thin film fixed bed TiO₂ photocatalyst comprising a reactor with at least an inert support forming the base thereof and walls rising from the said base, said inert support comprising at least two sides, a uniform film comprising a mixture of TiO₂ and binder affixed on one side thereof, inlets to allow flow of industrial wastewater over the uniform TiO₂ film coated support and outlets to allow outflow of treated industrial wastewater, said inert bed being open to exposure on the coated side thereof.

2. An apparatus as claimed in claim 1 wherein the inert support comprises a solid support.

3. An apparatus as claimed in claim 2 wherein the solid support comprises of Cuddapah stone obtained from Andhra Pradesh in India.

4. A method for the manufacture of an apparatus for photocatalytic treatment of industrial wastewater using a thin film fixed bed TiO₂ photocatalyst, said apparatus comprising a reactor with at least an inert support forming the base thereof and walls rising from the is said base, said inert support comprising at least two sides, a uniform film comprising a mixture of TiO₂ and binder affixed on one side thereof, inlets to allow flow of industrial wastewater over the uniform TiO₂ film coated support and outlets to allow outflow of treated industrial wastewater, said inert bed being open to exposure on the coated side thereof, said method comprising, mixing TiO₂ with a binder to form a TiO₂ milk, coating said inert support with said TiO₂ composition to form at least a first film layer and drying the coated support.

5. A method as claimed in claim 4 wherein the TiO₂ composition is coated with at least a further layer till a uniform fracture/pore free film layer is obtained immobilized on support.

6. A method as claimed in claim 4 wherein the TiO₂ comprises of TiO₂ Degussa P25 with particle size of 30 nm and surface area of 50 m²g⁻¹.

7. A method as claimed in claim 4 wherein the binder is selected from the group comprising of surfactants, acrylic emulsions and resins.

8. A method as claimed in claim 7 wherein the surfactants are selected from the group consisting of Doss 50%, Polyethylene glycol polymer (PEG-600), benzyl konium chloride 50% and VUBSOL- EL-40 (Fthoxylated product 40 moles (Castor oil based).

9. A method as claimed in claim 7 wherein the In another embodiment of the invention, the resin binder is ST-BA-AA resin.

10. A method as claimed in claim 4 wherein the the inert support is a solid support.

11. A method as claimed in claim 10 wherein the solid support comprises of Cuddapah stone obtained from Andhra Pradesh in India.

12. A method for the treatment of industrial wastewater comprising passing a wastewater stream over an apparatus comprising a reactor with at least an inert support forming the base thereof and walls rising from the said base, said inert support comprising at least two sides, a uniform film comprising a mixture of TiO₂ and binder affixed on one side thereof, inlets to allow flow of industrial wastewater over the uniform TiO₂ film coated support and outlets to allow outflow of treated industrial wastewater, said inert bed being open to exposure on the coated side thereof, and exposing said industrial wastewater to illumination to enable the degradation of the contaminants contained in said wastewater due to the catalytic activity of the TiO₂ film.

13. A method as claimed in claim 12 wherein the source of illumination is solar energy.

14. A method as claimed in claim 12 wherein the contaminants in the wastewater comprise para nitro phenol, para nitro toluene sulfonic acid, meta phenylene diamine sulfonic acid, Paracetamol, Dinitro stilbene disulphonic acid, H-acid, Diamino stilbene disulfonic acid, para amino phenol, para amino ozobenzene disulfonic acid, Acetic anhydride and K-acid.

15. A method as claimed in claim 12 wherein the TiO₂ composition is coated with at least a further layer till a uniform fracture/pore free film layer is obtained immobilized on support.

16. A method as claimed in claim 12 wherein the TiO₂ comprises of TiO₂ Degussa P25 with particle size of 30 nm and surface area of 50 m²g⁻¹.

17. A method as claimed in claim 12 wherein the binder is selected from the group comprising of surfactants, acrylic emulsions and resins.

18. A method as claimed in claim 17 wherein the surfactants are selected from the group consisting of Doss 50%, Polyethylene glycol polymer (PEG-600), benzyl konium chloride 50% and VIBSOL- EL-40 (Ethoxylated product 40 moles (Castor oil based).

19. A method as claimed in claim 17 wherein the resin binder is ST-BA-AA resin.

20. A method as claimed in claim 12 wherein the inert support is a solid support.

21. A method as claimed in claim 20 wherein the solid support comprises of Cuddapah stone obtained from Andhra Pradesh in India.
